(19) United States
(12) Patent Application Publication
(10) Pub. No.: US 2010/0247943 A1
(43) Pub. Date: Sep. 30, 2010

(54) METHOD FOR MANUFACTURING PANELS, FLOOR PANEL OBTAINED THEREWITH AND PRESS PLATEN APPLIED THEREWITH

(76) Inventors: Kurt Demeyere, Wingene (BE); Christof Vandevoorde, Machelen-Zulte (BE)

Correspondence Address: BACON & THOMAS, PLLC, 625 SLATERS LANE, FOURTH FLOOR, ALEXANDRIA, VA, 22314-1176, US

(21) Appl. No.: 12/724,506

(22) Filed: Mar. 16, 2010

(30) Foreign Application Priority Data
Mar. 26, 2009 (BE) 2009/0189

(51) Int. Cl. E04F 15/00; B32B 37/00; B32B 43/00

(52) U.S. Cl. 428/542.6; 156/60; 156/580

(57) ABSTRACT

Method for manufacturing panels having a substrate and a decorative layer, including at least the step of attaching at least the decorative layer on the substrate by means of a press element, wherein the press element used comprises at least three components, namely, a heating plate, a press mat and a press plate, wherein one or more components of the press element are made such that for one or more edges of said press mat more space or room is provided than for a central portion thereof.

### BACKGROUND OF THE INVENTION

1. Field of the Invention

This invention relates to a method for manufacturing panels, to floor panels obtained therewith and to press platens applied therewith.

2. Related Art

More particularly, the invention relates to panels having a substrate and a decorative layer provided on this substrate, as it can be the case with laminate panels.

Such panels are known as such. The substrates applied therewith can consist, for example, of wood particle board or wood fiberboard, such as MDF or HDF (Medium Density Fiberboard or High Density Fiberboard). According to the state of the art, such panels can be finished with a decorative layer or top layer at least at one flat side thereof. For example, from WO 97/47834 laminate floor panels are known, wherein MDF or HDF (Medium Density Fiberboard or High Density Fiberboard) is applied for the substrate and wherein for the decorative top layer, one or more paper layers provided on this substrate are applied. At least one of the aforementioned paper layers then is provided with a decorative print, for example, with a wood motif.

It is known that laminate panels, more particularly laminate floor panels, can be manufactured in a variety of ways. For example, they may be realized by means of a so-called DPL (Direct Pressure Laminate) technique. In such technique, at least the substrate and the decorative layer are provided in a press device, where, by means of a press treatment, they then are attached to each other by a press element. Herein, the decorative layer or top layer as such may be composed of one or more material sheets provided with resin or other synthetic material, which material sheets are connected to each other during the same press treatment.

Laminate floor panels may, for example, also be realized by means of a HPL (High Pressure Laminate) technique, wherein the material sheets provided with resin first are pressed together for forming a consolidated whole, which thereafter is provided on a substrate as the top layer, for example, is glued thereon.

Both in a DPL technique and a HPL technique, the laminate panels comprise a printed decor, which usually is provided on at least one of said material sheets and which determines the appearance of the decor side of the panels. This may relate, for example, to a printed decor with a wood pattern.

### SUMMARY OF THE DISCLOSURE

The present invention is particularly interesting for floor panels manufactured by means of a DPL technique.

In known press devices, which can be applied, for example, for manufacturing DPL laminate panels, the material to be pressed is placed between two press elements. Herein, each of the two press elements comprises at least three components, namely, a heating plate, a press mat and a press platen. Herein, the press platens are situated closest to a surface of the material to be pressed, whereas the heating plate is most remote from this surface. The press mat is situated between the press platen and the heating element. Usually, the heating element is made relatively solid and is heated by means of thermal oil or steam. Via the press mat and the press platen, the created heat is transferred to the surface of the material to be pressed. Herein, the press mat compensates possible unevennesses at the heating plate or at the press platen and enables transferring the pressure exerted to the heating plate relatively uniformly, or evenly, to the press platen and the surface of the material to be pressed. For examples of such press mats, reference is made to U.S. Pat. No. 6,040,253. A press platen or press plate usually consists of sheet steel, which can be structured at least on one flat side, namely, the side facing the surface of the material to be pressed, or pressing side. The negative of the structure of such press plate then can be copied in the surface of the pressed panel or board, with the intention of forming a relief at this surface. Such technique is described, for example, also in WO 01/96689.

For an example of such press device on a whole, reference is made to WO 98/07563. This document also shows that the heating plate, the press mat and the press platen usually are made with a larger surface than the panel to be pressed. WO 98/07563 describes a known problem which can occur in such press devices, namely, the loss of gloss at the edges of the press platen, which loss, with an increasing number of press cycles, is becoming more and more pronounced and copies itself in the surface of the pressed panel or the pressed board. The document concerned attributes the occurrence of this undesired effect to a bending of the edge regions of the press platen in combination with a difference in expansion between the decorative layer and the press platen at the usual pressing temperature and suggests as a solution to support the edges of the press platen with a frame or rack, the height of which corresponds to the thickness of the laminate to be pressed. This method, however, has the disadvantage that the press device becomes less accessible to the panel which has to be pressed or is pressed already. Adapting the thickness of the frame to the panel to be pressed is cumbersome and may lead to pressing faults when it is not performed accurately.

Moreover, the present inventors are of the opinion that this solution is inadequate for the surface quality of the present laminate. For example, the suggested solution leaves much to be desired when laminate having a high scratch resistance, wear resistance and/or gloss degree has to be manufactured.

The present invention aims at an alternative method, wherein the risk of the occurrence of gloss losses at the edges of the press platen, the pressed panels or boards, respectively, can be reduced and wherein, according to preferred embodiments, better results can be obtained than is the case with the solution of WO 98/07563, and/or a solution can be offered for the problems of the state of the art.

To this aim, the invention relates to a method for manufacturing panels having a substrate and a decorative layer provided on this substrate, wherein the method comprises at least the step of bringing at least said substrate and said decorative layer into a press device, wherein this press device comprises at least a press element and wherein the method also comprises a, whether or not directly, subsequent step of attaching at least said decorative layer on said substrate by means of this press element, wherein the press element applied herein comprises at least three components, namely, a heating plate, a press mat and a press platen, and wherein said press mat is situated between the heating plate and the press platen, with the characteristic that one or more components of said press element are made such that for one or more edges of said press mat more space is provided than for a central portion thereof. By “space”, the room available for the press mat between the press platen and the heating plate is meant.

It is clear that said decorative layer as such can be constructed of one or more layers, wherein then, of course, all of these layers are brought in the press device for there being pressed together with the substrate. It is also possible that during the same press treatment a layer is provided at the underside of the substrate, which possibly serves as a backing layer or balancing layer and at least partially counteracts warping of the pressed board or pressed panel.

The present invention is based on the insight of the inventors that the bending of the edge regions of the press platen presumably can be attributed substantially to the fact that, for example, in the case that the press mat, the press platen and the heating plate are made larger than the panel to be pressed, the press mat is impressed less at its edges than at its central portion. By now realizing, according to the invention, one or more components of said press element in such a manner that for one or more of these less impressed and thus thicker edges of said press mat, more space or room is provided than for a central portion thereof, it is obtained that the risk of bending of the edge regions of the press platen can be minimized and, as a consequence thereof, it is also obtained that the risk of loosing gloss at these edges already after a low number of press cycles, for example, less than 200 press cycles, can be minimized.

According to the most preferred embodiment of the method, said press platen, at its side facing away from the decor side of the panel, is provided with one or more deepened edges or recesses, wherein these deepened edges offer space or room for the respective edges of the press mat. According to a first possibility thereof, the aforementioned deepened edges can be obtained at least partially by removing a material portion at the respective edges of the press platen, for example, by milling away the edge up to a certain depth, for example, 0.5 to 3 mm deep and preferably approximately 1 mm deep. According to a second possibility thereof, said deepened edges may be obtained at least partially in that the press plate, centrally at its side facing away from the decor side of the panel, is provided with a separately applied material portion, for example, by centrally welding thereon a plate material with a smaller surface, or by centrally attaching such plate material in another manner, for example, by means of screws. It is clear that by “centrally” not necessarily a perfect centering is meant, but rather is meant that the edges are left free, whereas a middlemost portion of the respective side of the press platen is covered or decked by the applied material portion.

According to another preferred embodiment, at the surface of said heating plate one or more deepened edges are provided, which offer space or room for the respective edges of the press mat. According to a first possibility therefor, said deepened edges can be obtained at least by removing a material portion at the respective edges of the heating plate. This in turn is possible by a machining treatment, such as by means of a milling treatment. According to a second possibility therefor, said deepened edges may be obtained at least partially in that the heating plate centrally is provided with a separately applied material portion. This in turn is possible by centrally welding thereon a plate material with a smaller surface or attaching it in another manner, for example, by means of screws, whereas the edges of the plate substantially are kept free.

According to still another embodiment, said press platen comprises at least a fourth component, wherein this fourth component defines at least partially the difference in space or room between said central portion and the respective edges of the press mat. Preferably, the surface of said fourth component substantially corresponds to the surface of said central portion of the press mat, and this is positioned such that it is situated substantially only vertically above or vertically underneath this central portion, wherein then the absence of this fourth component at the respective edge provides the space for one or more of the less impressed edges of the press mat.

Preferably, the separately applied material portion, the fourth component, respectively, consists of a material having a better thermal conductivity coefficient than said press platen. For example, use can be made of a material comprising copper and/or lead and/or tin and/or zinc, or even substantially consisting of these materials or a mutual alloy of these materials. It is noted that a press platen or press plate preferably consists of steel, however, may also be realized from brass, copper or aluminum.

The invention is particularly suitable for being applied with methods in which said press device relates to a press which opens and closes, or a so-called short-cycle press or Kurztakt press. A press device of such type is well-known as such and is described, for example, in the already mentioned WO 98/07563.

Preferably, the method is applied for manufacturing so-called Direct Pressure Laminate or DPL panels, more particularly boards, which can be applied when manufacturing floor panels. By means of the press treatment of the invention, preferably larger boards are produced, from which a plurality of panels is obtained by subdividing them. Dividing may be performed by means of a saw treatment.

Preferably, the method is applied for manufacturing laminate panels which can at least be classified in class AC3 or AC4 according to EAN 13329. Namely, when manufacturing such panels, the wear of the press platen is particularly relevant. For the same reasons, the method of the invention is also particularly relevant for manufacturing laminate floor panels comprising a paper-free overlay. This means, in laminate floor panels which do not comprise a paper layer above the printed decor. When producing such laminate floor panels, a direct contact between the press platen and the hard particles situated in the paper-free overlay is difficult to avoid.

It is clear that the present invention also relates to a floor panel with the characteristic that it is obtained by subdividing a panel or board obtained by means of the herein above-described method.

Further, the invention, in an independent manner, also relates to a press platen for manufacturing laminate panels, with the characteristic that this press platen, at its side facing away from the press side, is provided with one or more deepened edges and/or recesses. Preferably, these edges or recesses are suitable for cooperating with the edges of a press mat, as also described herein above. It is clear that the herein above-mentioned first and second possibility are preferred embodiments thereof. Preferably, said deepened edges and/or recesses are obtained in that a material portion at the respective side is removed, for example, by means of a milling treatment. Preferably, such press element is provided with a structure at the press side, which structure preferably is obtained by etching and/or milling. Preferably, such press element is made chromium-plated at least at the press side.

In order to avoid the problems with press mats of the state of the art, it is also possible, according to a particular independent aspect of the present invention, to work with alternatives for these press mats. For example, it would be possible to work with a pressure-equalizing means, which in liquid form is brought onto the side of the press platen or press plate facing away from the press side and spreads between the heating plate and the press platen, for example, during performing several press cycles, and possibly solidifies there. In this manner, a transition between the heating plate and the press platen is created, which is very well attuned to these two components. For example, possible unevennesses at the surfaces of these two components can be filled by such pressure-equalizing means. Possibly the pressure-equalizing means can be renewed periodically. Preferably, the pressure-equalizing means relates to a means which is simple to remove. Preferably, the possible solidification of the means takes place at the normal press temperature, for example, at a temperature between 80 and 200° C. Preferably, a so-called thermo-hardening synthetic material, such as an amino resin, is applied.

Said particular aspect of the invention can be defined as a method for manufacturing panels having a substrate and a decorative layer provided on this substrate, wherein the method comprises at least the step of bringing at least said substrate and said decorative layer into a press device, wherein this press device comprises at least a press element and wherein the method also comprises a subsequent step of attaching at least said decorative layer on said substrate by means of this press element, wherein the press element applied herein comprises at least three components, namely, a heating plate, a pressure-equalizing means and a press platen, and wherein said pressure-equalizing means is situated between the heating plate and the press platen, with the characteristic that for the pressure-equalizing means a substance applied in liquid form is utilized. As this means, for example, a synthetic material-containing agent can be applied, such as an agent comprising silicone and/or Teflon and/or melamine. However, use can also be made of metal-containing agents, such as agents comprising zinc, tin, copper or lead. It is clear that by means of a method according to this particular aspect, problems with less impressed portions of the press mat can be completely avoided.

### BRIEF DESCRIPTION OF THE DRAWINGS

With the intention of better showing the characteristics of the invention, hereafter, as an example without any limitative character, some preferred embodiments are described, with reference to the accompanying drawings, wherein:

FIG. 1 schematically represents some steps in a method with the characteristics of the invention;

FIG. 2, at larger scale, represents a view on the area indicated by F2 in FIG. 1;

FIG. 3, at a larger scale, represents a cross-section according to the line indicated in FIG. 1;

FIG. 4, at a larger scale, represents a view on the area indicated by F4 in FIG. 1; and

FIGS. 5 to 7, in a view as that of FIG. 4, represent variants.

### DETAILED DESCRIPTION OF PREFERRED EMBODIMENTS OF THE INVENTION

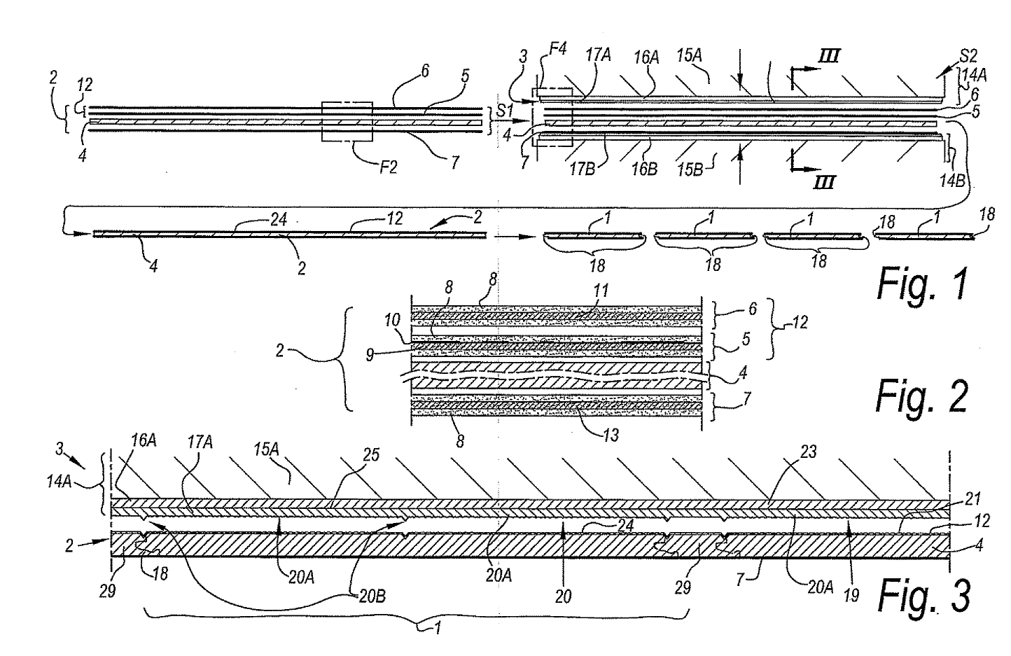

FIG. 1 represents some steps S1-S2-S3 in a method according to the invention, wherein in this case, this relates to a method for manufacturing floor panels 1, wherein it is started from board-shaped panels 2, which are subjected to a press treatment in a press 3.

In the schematically represented example of FIG. 1, the board-shaped panels 2 or boards are made as DPL (Direct Pressure Laminate), and the composing layers thereof are consolidated to a whole in the press device 3. Herein, the DPL is composed in a known manner of a substrate 4, preferably a MDF or HDF board (Medium Density Fiberboard or High Density Fiberboard), and one or more, in this case three, material layers 5-6-7 provided with resin, amongst which a printed decor layer 5.

For clarity's sake, the layered construction represented in FIG. 1 is shown more detailed in the enlarged view of FIG. 2, wherein the composing layers 4-5-6-7, which are to be pressed, are depicted at a distance one above the other. At the upper side of the substrate 4, there are two of the aforementioned material layers provided with resin, the aforementioned decor layer 5 and the so-called overlay 6, respectively. The decor layer 5 consists of a carrier sheet 9 provided with resin 8, for example, paper, which is printed with a decor 10. The overlay 6 consists of a carrier sheet 11 also provided with resin 8, for example, white paper, which becomes transparent after being pressed. In this overlay 6, preferably hard particles, such as corundum, are incorporated in order to impart a certain wear-resistance to the end product. In this example, said decor layer 5 and overlay 6 form the decorative layer 12 or top layer of the pressed panel 2 or the final floor panel 1. At the underside of the substrate 4, the third material layer 7 is present, which also consists of a carrier sheet 13 provided with resin 8 and which is intended for functioning as a backing layer. This backing layer 7 at least partially compensates a possible warping of the pressed board 2 as a result of shrinkage stresses in the top layer 12 by means of similar shrinkage stresses in the backing layer 7.

In a first step S1 of the method, the substrate 4 and the layers 5-6-7, amongst which the layers 5-6 forming the decorative layer 12 or top layer, are brought into a press device 3. There they are situated, in this case, between two press elements 14A-14B. In a, whether or not directly subsequent, second step S2, the aforementioned layers 5-6-7 are attached on the substrate 4 by means of pressure and heat supplied by the press elements 14A-14B.

FIGS. 1 and 3 clearly show that the upper press element 14A, or the press element situated closest to the decorative top layer 13, comprises at least three components 15A-16A-17A, namely, a heating plate 15A, a press mat 16A and a press platen 17A. The figures also show that the respective components 15A-16A-17A are made with a larger surface than the panel 2 or board to be pressed.

After pressing the board-shaped panels 2 or boards, wherein the substrate 4 and said material layers 5-6-7 are consolidated, these board-shaped panels 2, in the step S3, by means of one or more saw treatments, are sawn to floor panels 1, after which coupling means 18 are provided at the obtained edges of these floor panels 1, for example, by means of a milling treatment or in any other manner. A possible embodiment of the coupling means 18 to be realized is indicated in dashed line in FIG. 3. Preferably, these coupling means 18 are of the type which provides a vertical and horizontal locking when two of such floor panels 1 are coupled to each other. Examples of such coupling means 18 are widely known from the state of the art and are described, for example, in the patent documents WO 97/47834 and WO 01/98603.

Said press platen 17A, irrespective of its other characteristics, may be provided at the press side 19 with a structure 20 formed by unevennesses or projections for forming in this manner impressions or a relief 21 in the upper side of the board-shaped panels 2 during pressing. The structure 20 of the press platen 17A as such may be of different kind, such in function of the aimed at impressions or relief 21 to be formed.

In FIG. 3, as an example two structure forms 20A-206 at the press side 19 of the press platen 17A are represented. Herein, a first structure 20A consists of unevennesses or projections, which during pressing realize impressions forming a relief 21 in the surface of the pressed product, which relief imitates the natural surface of wood. Herein, the obtained impressions are such that they imitate the pores and/or nerves of wood. A second structure 20B, which is depicted in FIG. 3, is formed of unevennesses or projections which, during pressing, form impressions imitating removed material portions or deformed portions. In the example, this relates to unevennesses with which grooves are pressed into the surface of the board-shaped pressed panels 2 in order to thereby obtain, as represented, chamfers or the like.

It is clear that the application of a structure 20-20A-20B on the press platen 17A or the press plate is not restricted to the example thereof represented in FIG. 3. For example, also structures, unevennesses, respectively, may be applied, which imitate the natural and/or typical surface of other materials than wood, such as, for example, the surface of stone, ceramics or the like.

Also, almost microscopically small unevennesses may be applied on the press side 19 of the press platen 17a, which unevennesses, as is known, are applied for providing a matte appearance at the laminate surface or at certain portions thereof during pressing. It is also possible to work with a glossy press platen 17A.

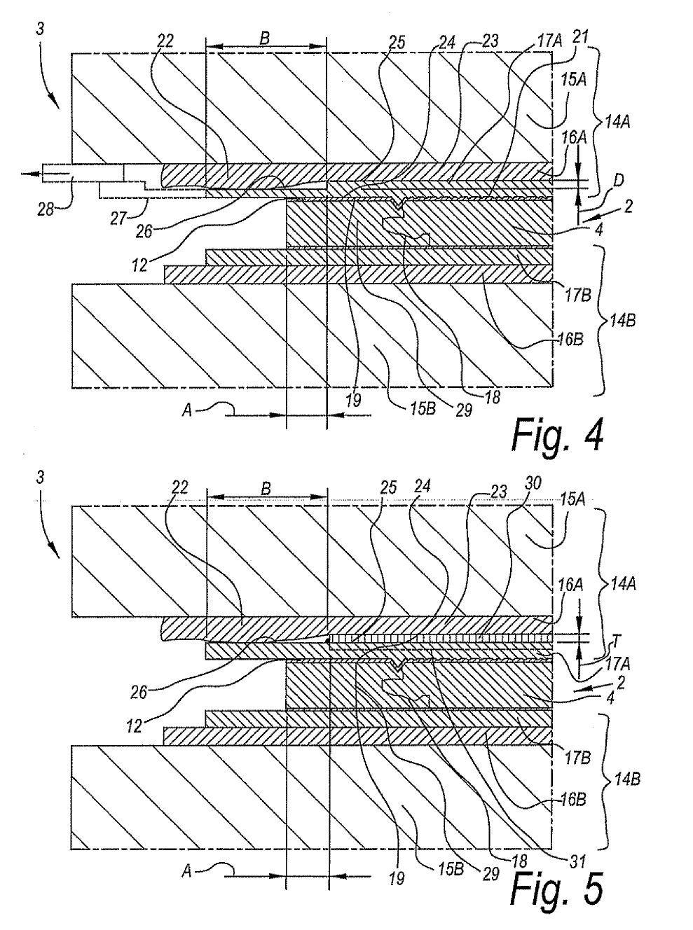

FIG. 4 shows the essence of the present invention. To wit, this is comprised in the fact that one or more components 15A-17A of the applied press element 14A are realized such that for one or more edges 22 of the aforementioned press mat 16A, more space or room is provided than for a central portion 23 thereof. In the case of FIG. 4, herein use is made of the possibility of providing the press platen 17A with deepened edges 26 at its side 25 facing away from the decor side of the panel, wherein these deepened edges 26 offer space or room for the respective edges 22 of the press mat 16A. In this case, the deepened edges 26 are obtained by removing a material portion at the respective edge 26 of the press platen 17A. The depth D of the deepened edge 26 preferably lies between 0.5 and 5 mm, wherein a depth D of approximately 1 to approximately 2 mm is a good value. The width B of the deepened edge preferably lies between 3 and 30 centimeters and still better between 5 and 15 centimeters. In the case of a recess instead of a deepened edge 26, the same values for depth D and width B for such recesses may be maintained. Such recess is present in the variant represented in dashed line 27. This variant moreover has the advantage that the press platen 17A still can be fixated in the press device 3 in the usual manner, namely by taking and tensioning this press platen 17A at the respective edges 26. Reference is made to WO 2006/136949, where the tensioning devices 28 known as such are represented. Working with recesses is particularly advantageous with the uppermost press platen 17A, and in particular at the long edges of such press platen 17A. Although it is not excluded that such recesses are applied at the short edges of the uppermost press platen 17A, too, they are not particularly useful at that location. Also when possibly applying the invention at the lowermost press platen 17B, recesses are not particularly useful in comparison with deepened edges, however, they are not excluded.

It is noted that the deepened edges 26 or the recess preferably, such as here, extends at least partially vertical above the board-shaped panel 2 to be pressed, over a distance A which is smaller than 15 millimeters and still better is smaller than 10 or 7 millimeters. By means of this preferred embodiment, any bending of the press platen 17A is avoided as much as possible. Preferably, the deepened edge 26 or the recess only extends above a so-called technical zone 29 of this board-shaped panel 2. Hereby, it is obtained that a possible loss of pressure on the edges of the panel 2 to be pressed is of limited importance. Such technical zones 29 are intended for being removed during the further processing of the pressed panel 2, for example, when subdividing it into smaller panels, and/or, such as here, when realizing profiled edge portions comprising, for example, coupling means 19.

FIG. 5 represents a variant, in which the deepened edges 26 of the press platen 17A are obtained in that the press platen 17A, centrally at its side 25 facing away from the decorative side 24 of the panel 2, is provided with a separately applied material portion 30. In this case, a plate with a smaller surface is welded onto the respective side 25. Such plate preferably has a thickness T corresponding to the herein above-mentioned preferred depths D of deepened edges 26 or recesses. However, it is also possible that such plate is partially incorporated in the respective side 25 of the press platen 17A, such as schematically represented by the dashed line 31. According to another possibility, the respective plate also can be provided apart from the press platen 17A, by which this plate forms a fourth component of the press element 14A. It is clear that it is also possible to form recesses by means of applied material portions, however, this is not represented here.

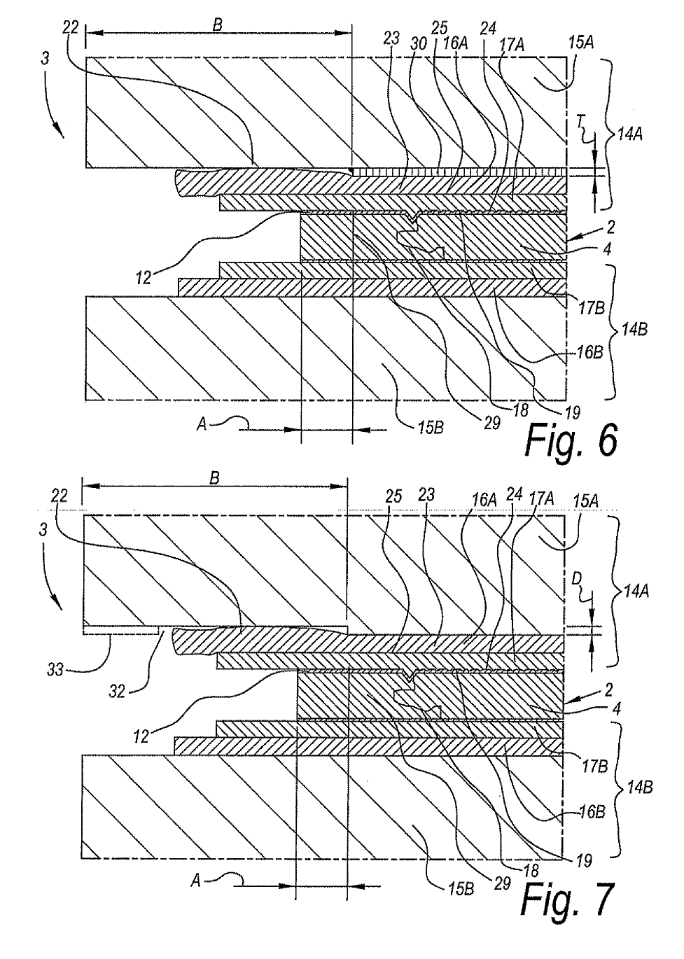

FIG. 6 shows another variant wherein such separate plate is welded on the heating plate 15A. It is evident that it here, according to a variant, can also be provided separately in its turn, as a result of which again a fourth component of the press element 14A is obtained.

FIG. 7 represents that deepened edges 32 of the heating plate 15A can also be obtained by removing a material portion at the respective edges 32 thereof. In dashed line 33, another variant is represented, in which use is made of recesses instead of deepened edges 32.

It is noted that providing additional space or room for the edges 22 of the press mat 16A-16B of course may be performed on all edges 22 of such press mat 16A-16B. Further, it is noted that preferably press devices 3 are used, which are made rectangular and oblong and wherein preferably, at least at the long edges of the press mat 16A-16B, additional space is provided. For example, a press device 3 of approximately 2 by 5 meters can be used.

Further, it is also noted that in the methods of the invention, preferably a pressure is applied which is situated between 10 and 70 bar, and a press temperature which is situated between 120° and 220° C. Preferably, the pressing time is between 5 and 50 seconds.

It is clear that, although in the appended figures the invention only is applied for the uppermost press element 14A, the invention can be applied for the lowermost press element 14B, or for both press elements 14A-14B as well. Preferably, the invention is at least applied at the press element 14A which is situated at the decor side 24 of the panel 2 to be pressed.

The present invention is in no way limited to the embodiments described herein above; on the contrary may such panels, methods and press platens be realized according to various variants, without leaving the scope of the present invention.

1. Method for manufacturing panels having a substrate and a decorative layer provided on the substrate, comprising bringing at least said substrate and said decorative layer into a press device, said press device comprising at least a press element, and then attaching at least said decorative layer on said substrate by means of the press element, said press element comprising at least three components, including a heating plate, a press mat and a press platen, and wherein said press mat is located between the heating plate and the press platen, and wherein one or more components of said press element are made such that for one or more edges of said press mat more space or room is provided than for a central portion thereof.

2. The method of claim 1, wherein said press platen, at its side facing away from a decor side of the panel, is provided with one or more deepened edges or recesses, wherein these deepened edges or recesses provide space for the respective edges of the press mat.

3. The method of claim 2, wherein said deepened edges or recesses are obtained at least partially by removing a material portion at the respective edges of the press platen.

4. The method of claim 2 or 3, wherein said deepened edges or recesses are obtained at least partially by the press platen having at its side facing away from the decor side of the panel a centrally separately applied material portion.

5. The method of claim 2 or 3, wherein at the surface of said heating plate, one or more deepened edges or recesses are provided, said edges or recesses providing space for the respective edges of the press mat.

6. The method of claim 5, wherein said deepened edges or recesses are obtained at least partially by removing a material portion at the respective edges of the heating plate.

7. The method of claim 5, wherein said deepened edges or recesses are obtained at least partially by the heating plate being centrally provided with a separately applied material portion.

8. The method of claim 1, wherein said press platen comprises at least a fourth component, said fourth component defining at least partially the difference of location between said central portion and the respective edges of the press mat.

9. The method of claim 8, wherein the surface of said fourth component corresponds to the surface of said central portion and is positioned such that it is situated substantially only vertically above or vertically underneath this central portion, wherein the absence of this fourth component at the respective edge provides for said difference in location.

10. The method of claim 8, wherein the separately applied material portion, namely the fourth component, comprises a material having a better thermal conductivity coefficient than said press platen.

11. The method of claim 10, wherein the separately applied material comprises copper and/or lead and/or tin.

12. The method of claim 2 or 3, wherein said press device relates to a so-called short-cycle press.

13. The method of claim 2 or 3, wherein it is used for manufacturing so-called Direct Pressure Laminate or DPL panels.

14. Floor panel obtained by dividing a panel obtained by means of a method according to claim 2 or 3.

15. Press platen for manufacturing laminate panels, comprising one or more deepened edges or recesses at a side facing away from a press side.
